(19) United States
(12) Patent Application Publication
(10) Pub. No.: US 2003/0049013 A1
(43) Pub. Date: Mar. 13, 2003

(54) Method and apparatus for encoding data bits

(76) Inventor: Gheorghe Sorin Stan, Eindhoven (NL)

Correspondence Address: U.S. Philips Corporation, 580 White Plains Road, Tarrytown, NY, 10591, US

(21) Appl. No.: 10/198,496

(22) Filed: Jul. 18, 2002

(30) Foreign Application Priority Data
Jul. 23, 2001 (EP) 01202820.5

(51) Int. Cl. H04N 11/02

(52) U.S. Cl. 386/33

(57) ABSTRACT

The invention relates to a method and an apparatus for encoding data bits of a data bitstream into channel bits of a channel bitstream to be recorded on a rewritable optical medium, wherein the digital sum value (DSV) of said channel bitstream is controlled. In order to provide a method and an apparatus for encoding as well as an optical recording medium which do not require any change in the electronics or software of a reproducing apparatus it is proposed according to the invention that the digital sum value of said channel bitstream is varied if a new part of channel bitstream is started to be recorded on the recording medium or if an old part of a channel bitstream is started to be rewritten at an identical location on the recording medium. Thus the method according to the invention is also applicable to any existent rewritable optical medium.

The invention relates to a method and an apparatus for encoding data bits of a data bitstream into channel bits of a channel bitstream to be recorded on a rewritable optical medium, wherein the digital sum value (DSV) of said channel bitstream is controlled. The invention relates further to a rewritable optical medium storing a channel bitstream encoded according to such a method.

It is known that rewritable optical media like CD−RW, DVD+RW exhibit ageing of the recording phase-change material after repetitive write/erase cycles. The number of direct overwrite cycles (DOW) has been theoretically estimated and experimentally proven to exceed 1000 for the recording materials used in CD−RW/DVD+RW/DVD−RW.

The DOW performance drops dramatically when exactly the same channel bit pattern is written at exactly the same location on the recording medium. This is, for instance, the case if the information in the file system areas, the Table of Contents (TOC) areas, or similar areas where management information is stored, are erased and rewritten again and again, although the contents of these data remain unchanged.

Another particular situation occurs right after the linking points when the encoder starts writing after being kept in hold with many of its parameters reset to default values. One of these parameters is the digital sum value (DSV) used to calculate the channel bitstream from the input data bitstream during or after modulation, e. g. EFM or EFMplus modulation. As the digital sum value is kept at zero before linking, the new channel bitstream always starts with identical bits if the user data does not change, which also reduces the DOW performance.

EP 0 974 957 A2 discloses a method and an apparatus for writing and reading optical recording media. Therein damage to the recording layer of an overwritable optical disc shall be reduced even if the same write data are repeatedly written to the same portion of the optical recording medium by converting write data. In addition, an identifier indicating the selected conversion method is written since the conversion method is selected at random at each overwriting operation. However, the proposed method is limited to certain optical recording media, and additional means are required in a reproducing apparatus in order to reproduce data stored on such an optical recording medium.

It is therefore an object of the present invention to provide a method and an apparatus for encoding as well as an optical recording medium for increasing the DOW cycles which do not require any change in the electronics or software of a reproducing apparatus. In addition, the method according to the invention shall be applicable to any existent rewritable optical medium, e. g. DVD-RAM, irrespective of the signal processing involved.

This object is achieved by a method of encoding as claimed in claim 1 according to which the digital sum value of the channel bitstream is varied if a new part of a channel bitstream is started to be recorded on the recording medium or if an old part of a channel bitstream is started to be rewritten at an identical location on the recording medium. This object is further achieved by an apparatus for encoding as claimed in claim 7 comprising appropriate means for controlling as well as by a rewritable optical medium as claimed in claim 9 storing a channel bitstream encoded according to a method as claimed in claim 1.

The invention is based on the idea that there are some freedom degrees in choosing the digital sum value which may be exploited to improve the DOW performance, in particular at the start of writing a new part of a channel bitstream or at the start of rewriting an old part of a channel bitstream on the recording medium, i. e. right after the linking points. According to the invention it is therefore proposed to vary the digital sum value at such points, i. e., to change the default value of the digital sum value which would be zero in most cases in order to minimize the low frequency content of the channel bitstream. It should be noted that ‘new part’ means data that has not yet been recorded on the particular medium earlier, while ‘old part’ in contrast means data that has already been recorded on the particular medium earlier.

According to a preferred embodiment it is proposed to control the digital sum value of said channel bitstream such that it does not start with zero if a new part of said channel bitstream shall be written on the recording medium. This means that if new data shall be appended or written on the recording medium a start DSV value shall be selected which is different from zero. However the subsequent modulation rules will drive the DSV forward zero as specified in the existing optical disc standard.

According to another preferred embodiment the digital sum value of said channel bitstream is controlled such that it is different from a previously set value if an old part of said channel bitstream shall be rewritten, in particular, if a part of a management information contained in said channel bitstream shall be rewritten. This situation appears when the information stored in a management information area, like file systems, table of contents or other management information, are erased and rewritten again and again, although most of these data remain unchanged.

According to the invention it is thus proposed to set the digital sum value forcefully to a non-optimum value at certain points. During read-out of the stored data the slicer will react somewhat differently. However, the slicer which calculates the DC value of the read-out signal is designed to accommodate such variations, as they also occur at defects on recording media and at the linking points. It should be noted once more that even if the start DSV is different from zero, it will be finally controlled toward zero by the channel modulator.

Preferably the digital sum value is randomly selected. Alternatively a register for registering the previously set digital sum value inside the encoder could be provided in order to vary the digital sum value from the previously set value.

In another preferred embodiment the digital sum value of the channel bitstream to be recorded is set such that it is different from the digital sum value calculated for said channel bitstream. This means that for the channel bitstream or a part thereof, preferably the start portion, the digital sum value is calculated correctly. The calculated value is, however, not used, but the digital sum value is intentionally set to a different value.

The invention relates also to an apparatus for rewriting data on a rewritable optical medium, like a CD or DVD, as claimed in claim 8 comprising an apparatus for encoding according to claim 7. It shall be understood that the apparatus as well as the rewritable optical medium as claimed in claim 9 can be developed further and can have similar further embodiments as explained above with reference to the method of encoding according to the invention.

The invention will now be explained in more detail with reference to the drawings in which

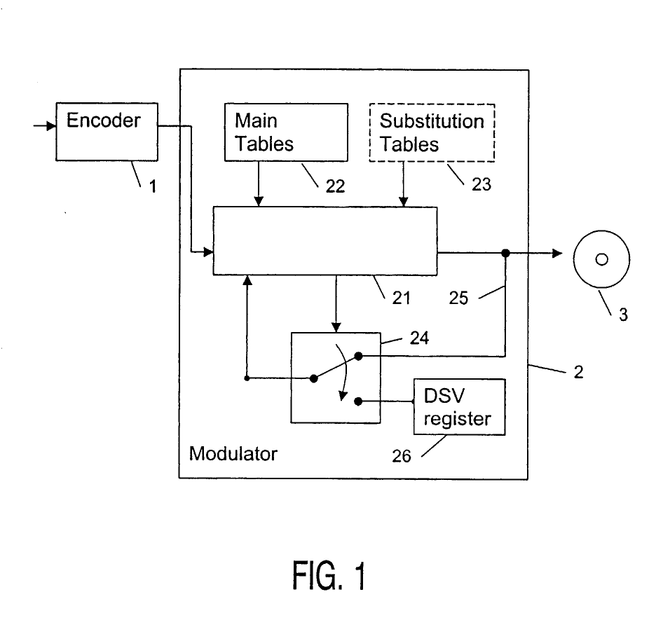

FIG. 1 shows a first embodiment of an apparatus for encoding according to the invention, and

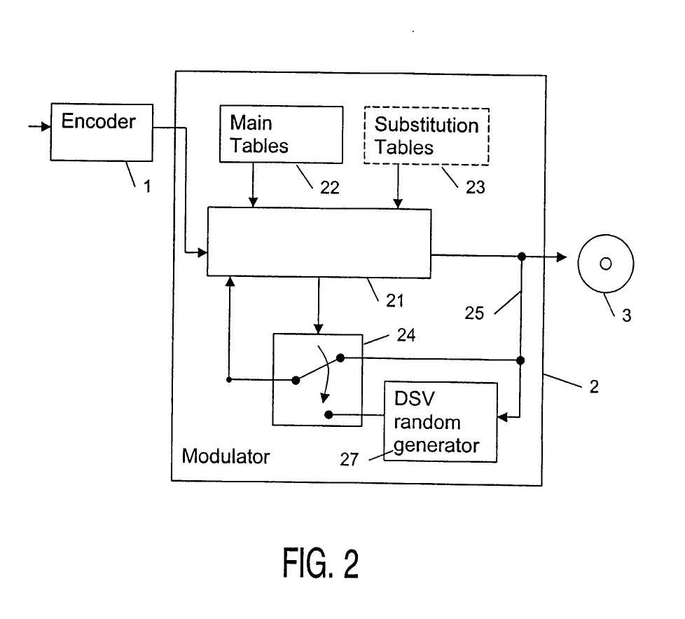

FIG. 2 shows a second embodiment of an apparatus for encoding according to the invention.

FIG. 1 shows a simple block diagram of an apparatus for encoding according to the present invention, preferably used for encoding data bits to be encoded and stored on a rewritable CD or a DVD. Therein are user data words output by some circuitry not shown in the figure (e. g. an analog-to-digital converter) encoded and provided with error correction capabilities by an encoder 1. Examples of such encoders are CIRC (Cross-Interleaved Reed-Solomon Code) or RSPC (Reed-Solomon Product Code). The obtained data stream is thereafter input into a modulator 2, which is an EFM (Eight-to-Fourteen modulation) modulator for CD and an EFMPlus modulator for DVD, wherein data words are mapped onto channel bits.

In order to fulfil required (d, k) constraints regarding the minimum and the maximum runlengths, means 21 for calculating and controlling the digital sum value are provided. In CD systems data words are mapped onto channel bits by use of a conversion table 22. In DVD systems the digital sum value is controlled by a more complex method based on primary and secondary sync codes and two tables, a main table 22 and a substitution table 23, which are used as conversion tables for mapping the data words onto channel bits.

According to the present invention, at certain points before writing part of a channel bitstream on the disc 3 the digital sum value is selected differently in order to vary the digital sum value intentionally within allowable limits and generate a sequence of channel bits different from a previous one.

Particularly, if a new part of a channel bitstream shall be recorded on the disc 3 the digital sum value is selected to be different from zero in order to prevent that, at the start of writing, an identical bitstream is recorded on the disc 3 at an identical position which would reduce the DOW performance of the disc 3. Another situation where the digital sum value is selected to be different from a previously set value and/or to be different from zero is when an old part of a channel bitstream shall be rewritten at an identical location on the disc 3 since this would also reduce the DOW performance of the disc 3. In all other situations the digital sum value is minimized according to the corresponding optical disc standard and brought as close as possible to zero.

In order to select between a digital sum value calculated according to the standard and another value a DSV control unit 24, in particular comprising a switch, is provided which is controlled by the unit 21. The DSV control unit 24 is thus able to select between the DSV value calculated according to the standard provided via line 25 and a DSV value preset in a DSV register 26. The value stored in the DSV register 26 is set to zero in the known apparatuses which value is used at the start of modulation process. According to the invention this value is set different from zero and may also be changed by the user or by a special algorithm. During the modulation process the DSV value calculation according to the standard and provided via line 25 is selected and fed back to unit 21.

Another embodiment of an apparatus for encoding according to the present invention is shown in FIG. 2. The only difference to the apparatus as shown in FIG. 1 is that instead of providing a DSV register a DSV random generator 27 is provided generating the digital sum value randomly. Thus, each time at the start of recording new data or at the start of rewriting old data to an identical location on the disc, in particular also at the linking points, a randomly selected digital sum value may be used by the DSV control unit 24 instead of using a digital sum value equal to zero according to the known method. According to the invention the DOW performance of rewritable optical media is improved without the need to make any changes in the software or hardware of reproducing apparatuses. The invention may also be applied to already existent optical recording media.

1. Method of encoding data bits of a data bitstream into channel bits of a channel bitstream to be recorded on a rewritable optical medium, wherein the digital sum value (DSV) of said channel bitstream is controlled, characterized in that the digital sum value (DSV) of said channel bitstream is varied if a new part of a channel bitstream is started to be recorded on the medium or if an old part of a channel bitstream is started to be rewritten at an identical location on the medium.

2. Method according to claim 1, characterized in that the digital sum value (DSV) of said channel bitstream is set such that it does not equal zero at the start of the modulation process if a new part of said channel bitstream shall be recorded on the medium.

3. Method according to claim 1, characterized in that the digital sum value (DSV) of said channel bitstream is controlled such that it is different from a previously set value if an old part of said channel bitstream shall be rewritten, in particular if part of a management information contained in said channel bitstream shall be rewritten.

4. Method according to claim 1, characterized in that the digital sum value (DSV) is randomly selected at the start of the modulation process.

5. Method according to claim 1, characterized in that the digital sum value (DSV) of said channel bitstream is preset such that it does not equal zero at the start of the modulation process and/or that it is different from a previously set value.

6. Method according to claim 1, characterized in that the digital sum value (DSV) of said channel bitstream at the start of the modulation process is set such that it is different from the digital sum value calculated for said channel bitstream.

7. Apparatus for encoding data bits of a data bitstream into channel bits of a channel bitstream to be recorded on a rewritable optical medium comprising means for controlling the digital sum value (DSV) of said channel bitstream, characterized in that said means for controlling the digital sum value (DSV) of said channel bitstream are provided for varying the digital sum value (DSV) if a new part of a channel bitstream is started to be recorded on the medium or if an old part of a channel bitstream is started to be rewritten at an identical location on the medium.

8. Apparatus for rewriting data on a rewritable optical medium comprising an apparatus for encoding according to claim 7.

9. Rewritable optical medium storing a channel bitstream encoded according to a method of claim 1, wherein the digital sum value (DSV) of said channel bitstream is controlled, characterized in that the digital sum value (DSV) of said channel bitstream is varied if a new part of a channel bitstream is started to be recorded on the medium or if an old part of a channel bitstream is started to be rewritten at an identical location on the medium.

10. Medium according to claim 9, wherein the medium is a rewritable CD or DVD.
